(19) United States
(12) Patent Application Publication
(10) Pub. No.: US 2021/0065321 A1
(43) Pub. Date: Mar. 4, 2021

(54) METHOD AND APPARATUS FOR AN AUTOMATED SOCIAL DISPUTE RESOLUTION PLATFORM

(71) Applicant: MOKK TRIAL PTY LTD., Ulladulla (AU)

(72) Inventors: Blake McKenzie, Sydney (AU); Simon Brazell, Sydney (AU)

(21) Appl. No.: 17/010,232

(22) Filed: Sep. 2, 2020

Related U.S. Application Data
(60) Provisional application No. 62/894,896, filed on Sep. 2, 2019.

(51) Int. Cl. G06Q 50/18; G06Q 50/26; H04L 29/08

(52) U.S. Cl. CPC G06Q 50/18; H04L 67/02; G06Q 50/26

(57) ABSTRACT

Systems, devices, and methods including a processor configured to: generate a case based on the completed case creation form; apply a served state to the generated case; generate a deadline for the second user computing device to accept the generated case in the served state; apply a removed state to the generated case if the second user computing device does not accept the generated case within the generated deadline; apply a summoned state to the generated case if the second user computing device accepts the generated case within the generated deadline; generate a deadline for the set of one or more third user computing devices to accept the generated case in the summoned state; determine a verdict based on the determined judgment of the at least one fourth user computing device; and apply a closed state to the generated case after the verdict is determined.

### CROSS-REFERENCE TO RELATED APPLICATIONS

This application claims priority to and the benefit of U.S. Provisional Patent Application No. 62/894,896, filed Sep. 2, 2019, the contents of which are hereby incorporated by reference herein for all purposes.

### TECHNICAL FIELD

Embodiments relate generally to dynamic matching and establishing communication channels for a social dispute platform, and more particularly to an automated social dispute resolution platform.

### BACKGROUND

Disputes may be resolved with the intervention of third parties, for examples, court systems. Pre-existing biases on behalf of a judge and/or jury may influence decisions and judgement levied by the judge and/or jury members.

### SUMMARY

The disclosed system, method, and device embodiments provide virtual or automated court systems that may be more flexible and speed up processing of social disputes more rapidly than a traditional court system. The presented embodiments address scenarios where within a virtual or online court system there may exist inherent bias when it comes to social dispute resolutions. For example, bias may be based on name, gender, age, ethnicity, and the like, resulting in online bullying and harassment.

A system embodiment may include an automated social dispute resolution platform comprising: a web-enabled, back-end computing device and a user computing device. The user computing device may include an operating system supporting a web browser and at least one application, a processor, and a user interface. In one embodiment, a user may log in to the social dispute resolution platform and the processor may execute steps to run the at least one application, and the at least one application may allow for the user to send and receive images and files. In one embodiment, a second user may interact with the received images and files via a web browser of the web-enabled, back-end computing device.

In one embodiment, the user is a visitor, and the user may create an account, log into the account, and view a social feed. In another embodiment, the user is a plaintiff and the plaintiff creates a new case to be ruled on. In another embodiment, the user is a defendant, and the defendant may provide written evidence and one picture so that a judge may make an informed verdict. In another embodiment, the user is a witness, and the witness may provide written evidence and one picture within a timeframe so a judge may make an informed verdict. In another embodiment, the user is a judge, and the judge may receive notification that cases are available, and select a case to preside over. In another embodiment, the user is an anonymous social feed judge, and the anonymous social feed judge may choose categories of interest, receive notification that social cases are available, and browse the social case feeds.

A system embodiment may include: a first user computing device having a processor and addressable memory, where the processor of the first user computing device may be configured to: complete a case creation form, where the case creation form comprises written evidence and at least one image; transmit the completed case creation form; a second user computing device having a processor and addressable memory, where the processor of the second user computing device may be configured to: transmit a defendant case served form, where the case served form may be based on the completed case creation form; a set of one or more third user computing devices having a processor and addressable memory, where the processor of the set of one or more third user computing devices may be configured to: transmit a witness case served form, where the case served form may be based on the completed case creation form; at least one fourth user computing device having a processor and addressable memory, where the processor of the at least one fourth user computing device may be configured to: determine a judgement based on: the completed case creation form and the defendant case served form; a web-enabled, back-end computing device, where the processor of the web-enabled, back-end computing device may be configured to: generate a case based on the completed case creation form; apply a served state to the generated case; generate a deadline for the second user computing device to accept the generated case in the served state; apply a removed state to the generated case if the second user computing device does not accept the generated case within the generated deadline; apply a summoned state to the generated case if the second user computing device accepts the generated case within the generated deadline; generate a deadline for the set of one or more third user computing devices to accept the generated case in the summoned state; remove at least one third user computing device from the set of one or more third user computing devices if the at least one third user computing device does not accept the generated case within the generated deadline; apply an opened state to the generated case after at least one of: the transmitted witness case served form may be received and the at least one third user computing device may be removed; determine a verdict based on the determined judgment of the at least one fourth user computing device; and apply a closed state to the generated case after the verdict may be determined.

In additional system embodiments, the processor of the web-enabled, back-end computing device may be further configured to: send a notification to the first user computing device when the generated case may be in the summoned state. In additional system embodiments, applying the served state to the generated case further comprises: determine, by the processor of the web-enabled, back-end computing device, if the second user computing device has a user account. In additional system embodiments, the processor of the web-enabled, back-end computing device may be further configured to: send an account creation link to the second user computing device if the second user computing device does not have the user account; and create the user account based on the sent account creation link. In additional system embodiments, the processor of the web-enabled, back-end computing device may be further configured to: send a push notification to the user account of the second user computing device.

In additional system embodiments, applying the opened state to the generated case further comprises: determine, by the processor of the web-enabled, back-end computing device, if a third user computing device from the set of one or more third user computing devices has a user account. In additional system embodiments, the processor of the web-enabled, back-end computing device may be further configured to: send an account creation link to the third user computing device if the third user computing device does not have the user account; and create the user account based on the sent account creation link. In additional system embodiments, the processor of the web-enabled, back-end computing device may be further configured to: send a push notification to the user account of the third user computing device.

In additional system embodiments, transmitting the witness case served form further comprises transmitting written evidence. In additional system embodiments, transmitting the witness case served form further comprises transmitting at least one image. In additional system embodiments, the processor of the web-enabled, back-end computing device may be further configured to: send the determined verdict to the first user computing device, the second user computing device, and the set of one or more third user computing devices. In additional system embodiments, the processor of the at least one fourth user computing device may be further configured to: determine a judgement further based on the transmitted witness case served form. In additional system embodiments, the processor of the web-enabled, back-end computing device may be further configured to: apply an appealed state to the generated case if the first user computing device requests an appeal.

In additional system embodiments, the processor of the web-enabled, back-end computing device may be further configured to: apply an appealed state to the generated case if the first user computing device requests an appeal. In additional system embodiments, the processor of the web-enabled, back-end computing device may be further configured to: send the generated case in the appealed state to a pool of a set number of the at least one fourth computing devices; receive votes from the pool of the set number of the at least one fourth computing devices; determine a verdict on the generated case in the appealed state based on the received votes; and apply a closed state to the generated case after the verdict may be determined.

A method embodiment may include: completing, by a processor of a first user computing device, a case creation form, where the case creation form comprises written evidence and at least one image; transmitting, by the processor of a first user computing device, the completed case creation form; transmitting, by a processor of a second user computing device, a defendant case served form, where the case served form may be based on the completed case creation form; transmitting, by a processor of a set of one or more third user computing devices, a witness case served form, where the case served form may be based on the completed case creation form; and providing, by a processor of at least one fourth user computing device, a judgement based on: the completed case creation form, the defendant case served form, and the witness case served form.

Additional method embodiments may include: generating, by a processor of a web-enabled, back-end computing device, a case based on the completed case creation form; and applying, by the processor of a web-enabled, back-end computing device, a served state to the generated case. Additional method embodiments may include: generating, by the processor of a web-enabled, back-end computing device, a deadline for the second user computing device to accept the generated case in the served state; applying a removed state to the generated case if the second user computing device does not accept the generated case within the generated deadline; and applying a summoned state to the generated case if the second user computing device accepts the generated case within the generated deadline.

Additional method embodiments may include: generating, by the processor of a web-enabled, back-end computing device, a deadline for a third user computing device from the set of one or more third user computing devices to accept the generated case in the summoned state; removing, by the processor of a web-enabled, back-end computing device, the third user computing device if the third user computing device does not accept the generated case within the generated deadline; and applying an opened state to the generated case after at least one of: the transmitted witness case served form may be received and the third user computing device may be removed. Additional method embodiments may include: determining, by the processor of a web-enabled, back-end computing device, a verdict based on the determined judgment of the at least one fourth user computing device; and applying, by the processor of a web-enabled, back-end computing device, a closed state to the generated case after the verdict may be determined.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a system for automated social dispute resolution;

FIG. 2 illustrates an example top-level functional block diagram of a computing device embodiment;

FIG. 3 shows a high-level block diagram and process of a computing system for case creation in the system of FIG. 1;

FIG. 4 shows a high-level block diagram and process of a computing system for a judgement process in the system of FIG. 1;

FIG. 5 shows a high-level block diagram and process of a computing system for an appeal process in the system of FIG. 1;

FIG. 6 shows a high-level block diagram and process of a computing system for implementing an embodiment of the system and process;

FIG. 7 shows a block diagram and process of an exemplary system in which an embodiment may be implemented;

FIG. 8 depicts a cloud computing environment for implementing an embodiment of the system and process disclosed herein; and

FIG. 9 depicts a high-level block diagram of a computing system for an automated dispute resolution platform.

### DETAILED DESCRIPTION

The disclosed system, method, and device embodiments provide virtual or online systems that are more flexible and speed up processing of social disputes more rapidly than a traditional system via establishing direct communication channels between the parties. The presented embodiments as described improve the efficiency of and address scenarios where within a virtual or online court system there may exist inherent bias when it comes to social dispute resolutions. For example, bias may be based on name, gender, age, ethnicity, and the like, resulting in online bullying and harassment.

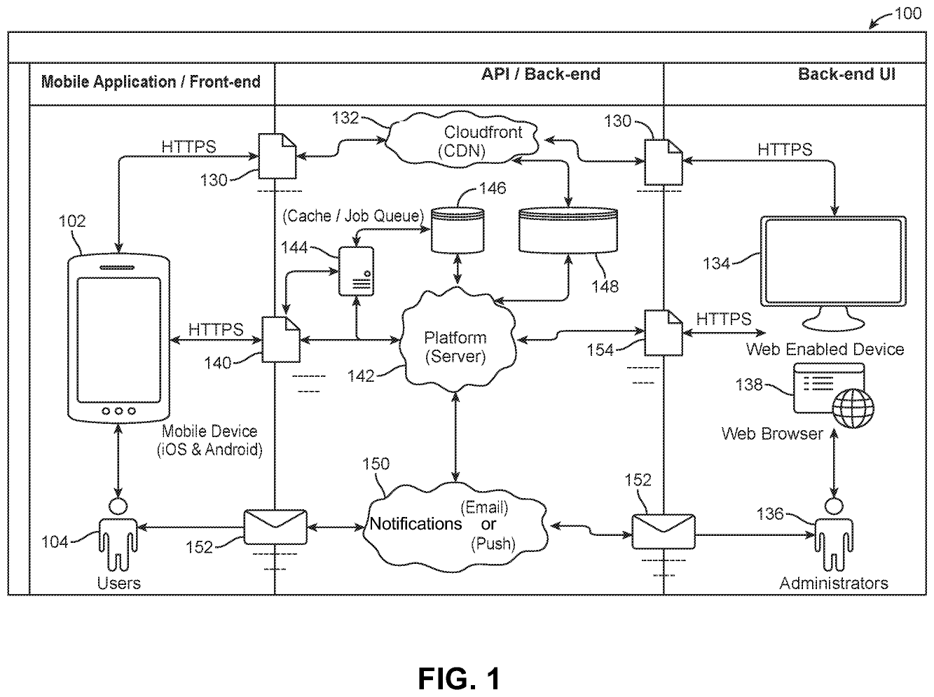

With respect to FIG. 1, a system 100 allows for automated social dispute resolution. In one embodiment, the system 100 provides for social disputes to be resolved without the intervention of courts or court appointed “alternative dispute resolution” (ADR). As such, system 100 may be a mock court system and process data flow that follows the progression of case lodgment by a plaintiff, serving of papers on defendant, submission of evidence, judgement, and/or appeal. In one embodiment, the system architecture, using a processor and addressable memory, presents cases anonymously with only titles of “Plaintiff,” “Defendant,” or “Witness” shown to one or more Judges via an established communication channel using their respective computing devices, for example, user equipment.

In one embodiment, the system 100 provides a computing device running a software/hardware platform for social dispute resolution and applications to be executed on the computing devices. A user may choose categories of interest for which they themselves act as judges in a particular case. As such, any user using the platform may function as a judge and may be selected for judgement or jury duty. This selection may be random in some embodiments. This selection may be to voluntarily participate in a social feed in some embodiments. In the social feed, the users, such as user 104 may leave comments and verdicts which can be viewed by all participating users. Additionally, users may create cases for which they become the plaintiff. Furthermore, they may then invite the defendant and the witnesses into the platform to put forth their side of the transpired events and provide evidence.

In one embodiment, judges may only ever be presented users under the titles Plaintiff or Defendant, and no further information on either party will be available for the Judge. This allows users to be open, honest, and forthright with information as the users know only what evidence the users provide will be counted and not the fact that they present as a category for bias. For example, when presented with a user's profile, photo, or username, a Judge's personal user bias may be introduced, such as bias based on gender, race, and/or or a socioeconomic status. In one embodiment, said biases may be negated by only providing evidence and keeping user identities anonymous.

In one embodiment, a user has a choice of having the user's case (or cases) judged privately within a closed system or publicly on a social feed. All social cases must be agreed to by both Plaintiff and Defendants; otherwise, they will remain within the private closed system. It is noted that the system 100 is purely social and is not legally binding. System 100 further provides for a safe forum for open discussion and dispute resolution. Additionally, system 100 affords 24 hour access to independent social judges, while also removing bias. More specifically, a user's own bias may influence decision making and judgement. For example, system 100 shifts the focus to the evidence of a court case rather than a user's profile. This is due to the fact that when presented with a user's profile, photo or username bias may be introduced. System 100 provides for negating this bias by only providing evidence initially, since bias may be introduced by the user if the user chooses to submit name, gender, age, ethnicity etc. System 100 allows for anonymity and a safer social environment to reduce online bullying and harassment.

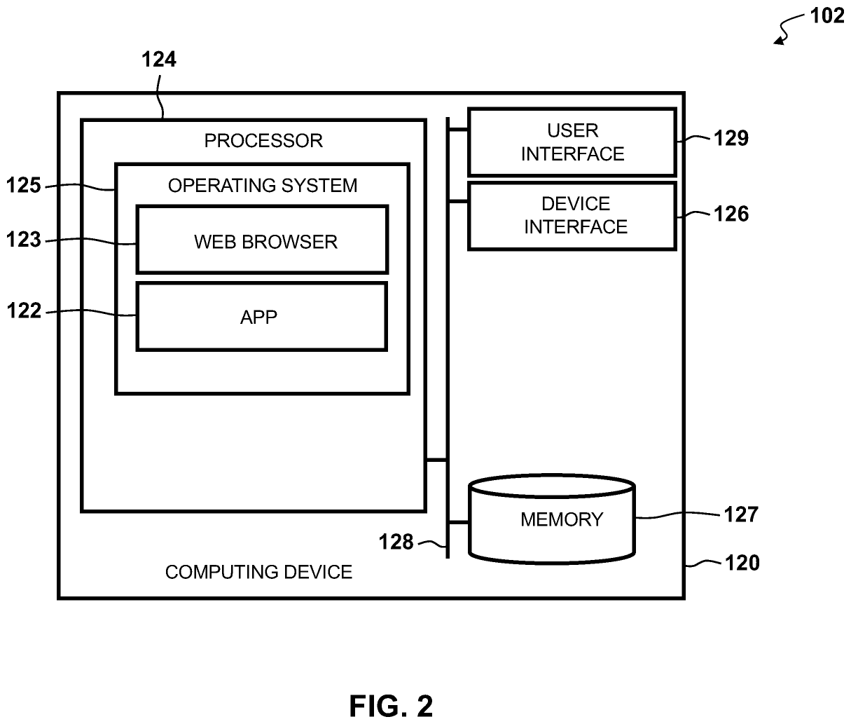

In one embodiment, a user 104 may sign up to use the social dispute resolution platform via a user computing device 102. The user computing device 102 may be a mobile device, tablet, personal computer, or the like. More specifically, and with respect to FIG. 2, an example of a top-level functional block diagram of the user computing device 102 is shown. The computing device 102 comprises a processor 124, such as a central processing unit (CPU), addressable memory 127, an external device interface 126, e.g., an optional universal serial bus port and related processing, and/or an Ethernet port and related processing, and an optional user interface 129, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 128. In some embodiments, via an operating system 125 such as one supporting a web browser 123 and applications 122, the processor 124 may be configured to execute steps of a process establishing wireless communication with a second web-enabled, back-end device.

With respect to FIG. 1, the user 104 may interact with the user computing device 102 through the user interface 129 described above. The user 104 may be a plaintiff, defendant, judge, or expert witness for either the plaintiff or the defendant, an anonymous social feed judge, or a visitor to the system 100. If the user 104 is a visitor, the user 104 may create an account, log into an account, and view the social feed.

In one embodiment, if the user 104 is a plaintiff, the plaintiff first creates a new case as a user so that it may be ruled on. The user 104 as a plaintiff may then select a category for the plaintiff's case (which may be judged by other users interested in that topic), and provide written evidence and a picture. The plaintiff may also list one defendant, list one witness, specify his or her case to be private or social, and share the plaintiff's case to social media. In some embodiments, the plaintiff may list two or more defendants and/or two or more witnesses. The plaintiff may also appeal a verdict, share the verdict of the judged case to social media, and rate the judgement on a graphic rating scale.

In one embodiment, if the user 104 is a defendant, the defendant may provide written evidence and one picture so that the judge may make an informed verdict. The defendant may also list one witness to provide evidence, agree to social judgement, choose a private judgement, share the case on social media, appeal a verdict, share said verdict of the judged case to social media, and rate the judgement on a graphic rating scale. In some embodiments, the defendant may provide two or more pictures and/or two or more witnesses.

In one embodiment, if the user 104 is a witness, the witness may provide written evidence and one picture within a timeframe so the judge may make an informed verdict. In some embodiments, the witness may provide two or more pictures. The witness may be notified of the verdict and rate the judgement on a graphic rating scale. While pictures are discussed, the pictures may be replaced with videos in some embodiments.

In one embodiment, if the user 104 is a judge, the judge may receive notification that cases are available, and select a case to preside over. The judge may rule in favor of either the plaintiff or the defendant so that judgement may be delivered. The judge may further choose categories of interest so that the user may preside over cases that hold the user's interest. The judge may receive “reputation points” to earn virtual “badges” to improve the judge's standing within the mock court system platform 100. The judge may review the judge's old cases and also review the judge's old badges.

In one embodiment, if the user 104 is a social judge, the social judge may choose categories of interest, receive notification that social cases are available, and browse the social case feeds. The social judge may also vote in favor of either the plaintiff or the defendant so that judgement may be delivered. The social judge may receive “reputation points” when the user's vote is cast in order to earn virtual badges. The social judge may leave comments when voting. The social judge may agree with another social judge's comment or comments. Finally, the social judge may share any social case to social media so that the social judge's connections on social media may view and vote on the case as well.

In one embodiment, a user, such as user 104 may interact with the social platform system 100 with the user computing device 102 through the user interface 129 described above. The user may log in to the platform and the processor 124 may execute steps to run the application 122. The application 122 may allow for the user 104 to send and receive images and files 130 with, for example, Hypertext Transfer Protocol Secure (HTTPS). HTTPS may be used for secure communication over a computer network, such as on the internet. The images and files 130 may be delivered and received with a content delivery network (CDN) 132. CDN 132 may be a service that securely delivers data, videos, applications, and APIs to other users with low latency and high transfer speeds. The CDN 132 may then send and receive images and files 130 with HTTPS to a second, web-enabled, back-end computing device 134. A second user 136, such as an administrator (or administrators) may interact with the received images and files 130 via a web browser 138 of the computing device 134. In one embodiment, servers (e.g., Amazon Web Services (AWS) Cloudfront® servers) are optimized for serving static files and located around the world. Using Domain Name System (DNS), any requests for a particular asset are routed to the edge cache location closest to the user, thereby greatly speeding up load times for these assets.

In one embodiment, the user 104 may send and receive data 140 with HTTPS to a job queue 144 that may communicate with a remote, cloud-based server 142. In one embodiment, the data is JavaScript Object Notation data, which is an open-standard file format that uses human-readable text to transmit data objects consisting of attribute-value pairs and array data types. In one embodiment, the remote server 142 may be a Heroku Platform. The remote server 142 may also interact with the CDN 132 to send and receive information via a file storage device 148. The remote server 142 and the job queue 144 may send and/or receive information from a database 146. The remote server 142 may also send and receive files 154 to the computing device 134 with HTTPS. File examples include HTML, CSS, JavaScript, and the like.

The remote server 142 may also communicate with the user 104 and/or the administrator 136 via email or push notifications 152. In one embodiment, the remote server 142 communicates with a cloud-based service 150 for email and push notifications. In one embodiment, the email delivery service is Mailgun®. In one embodiment, the push notification delivery service is OneSignal®.

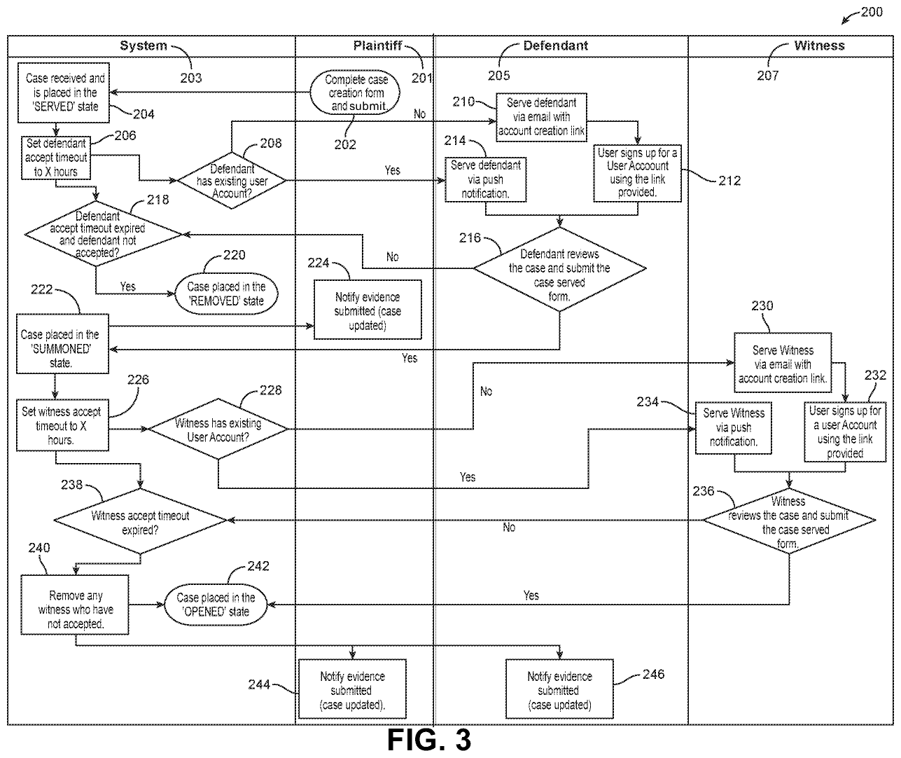

With respect to FIG. 3, a process 200 for case creation within the system platform 100 of FIG. 1 is illustrated. At step 202, a plaintiff 201 opens the application 122 on the user computing device 102 to complete a case creation form and submits the form. In one embodiment, the processor 124 of the user computing device 102 may sort the case into a “state” based on the status of the case. Sorting or “placing” of the case into states provides for efficient processing and judgment of a case. For example, and at step 204, the case is received in a system 203 and sorted into a “SERVED” state. In some embodiments, the system 203 may be a web-enabled, back-end computing device 134, a remote server 142, and/or a CDN 132 as disclosed above. In some embodiments, the plaintiff, defendant, and witness may be user computing devices 102, as disclosed above. At step 206, the system 203 may set a defendant 205 accept timeout to X hours. At step 206, the system 203 determines if case removal may be warranted by following the below noted steps. In one embodiment, the X number of hours of step 206 may be adjusted by the system 203. At this stage, the system 203 determines if the defendant 205 has an existing user account (step 208). If the defendant 205 does not have an existing user account then the defendant 205 is served an account creation link via email, at step 210. At step 212, the defendant 205 may sign up for a user account using the link provided at step 210. If the defendant already has a user account, the defendant 205 is served via push notification at step 214. At step 216, the defendant 205 reviews the case and submits the case served to the defendant 205. At step 218, if the “defendant accept timeout” period from step 206 has expired and the defendant 205 has not accepted the case due to lack of action for existing users or no account creation for potential users, then the case is placed in the “REMOVED” state at step 220.

Returning to step 216, upon the defendant 205 reviewing the case and submitting the cased served form via the application 122 on the user computing device 102, the case is place in the “SUMMONED” state in the system 203 at step 222. At step 224, the plaintiff 201 is notified. After the case has been placed in the “SUMMONED” state, the system 203 sets a witness 207 accept timeout to X hours, at step 226. More specifically, at step 226 the system 203 may determine if case progression to a step 242 (described in detail below) where the case may be placed in an opened status is warranted by following step 228. The 228 variable is adjustable in the backend admin system.

At step 228, the system 203 checks to see if the witness 207 has an existing user account. If the witness 207 does not have an existing user account, then the witness 207 is served an account creation link via email, at step 230. At step 232, the witness 207 may sign up for a user account using the link provided at step 230. If the witness 207 already has a user account, the witness 207 is served via push notification at step 234. At step 236, the witness 207 reviews the case and submits the case served to the witness 207.

At step 238, if the witness 207 did not review the case and submit the case served form in step 236 and if the accept timeout expired, then the witness 207 is removed by the system 203 at step 240, and the case is placed in the “OPENED” state at step 242. Additionally, if no witnesses were added at all by Plaintiff 201 or Defendant 205 then step 216 progresses directly to step 242. If the witness 207 did review the case and submit the case served form in step 236, then the case is placed in the “OPENED” state at step 242.

At step 244, the plaintiff 201 is notified of evidence submitted upon removal of any witness who has not accepted (step 240). At step 246, the defendant 205 is notified of evidence submitted upon removal of any witness who has not accepted (step 240).

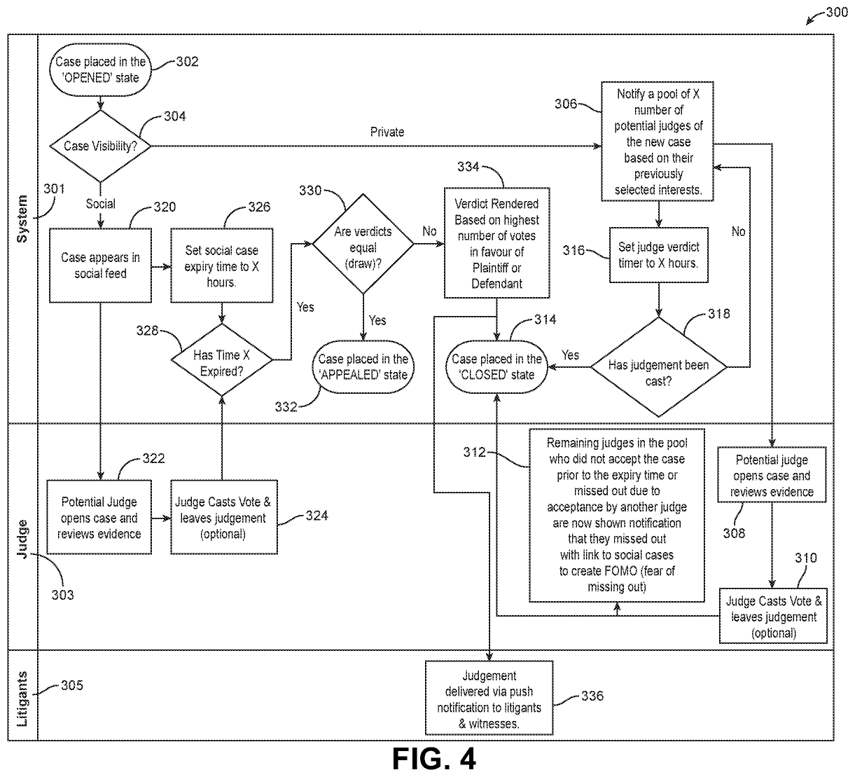

With respect to FIG. 4, a method 300 for judgement process within the system platform 100 of FIG. 1 is illustrated. At step 302, a case is placed in the “OPENED” state within a system 301, thereby opening a case to begin a judgement process. At step 304, the visibility of the case is determined within the system 301, with the visibility of the case being either private or social. If the case is private, then at step 306 a pool of X number of potential judges of the new case (based on their previously selected interests) are notified on each potential judge's computing device 102 via service 150, such as a push notification if a token on the server is active showing that the user has signed in and has a unique mobile device attached to their profile, such as “Onesignal player ids” (e.g., c197eb02-a849-45cb-8c6f-95b8dc8802c2) being a unique device identifier or alternatively notified by email. At step 308, a potential judge 303 opens the case and reviews the evidence opened with the application 122 on the user computing device 102. At step 310, the potential judge 303 casts a vote via submitting on their computing device . In one embodiment, the potential judge 303 may leave an opinion. At step 312, the remaining judges in the pool who did not accept the case prior to the expiry time (or missed out due to the acceptance by another judge) are shown a notification that they missed out. In one embodiment, the remaining judges are notified via a link from service 150 being push notifications if a token is active or alternatively by email. In one embodiment, the link may indicate, for example, “You are too late for this one, but there are plenty more cases” creating fear of missing out, as the user is not quick enough to accept misses out on being able to judge the case. This may be achieved by making case acceptance a so-called “first-in-first-served” competition. In one embodiment, the notification may provide a button with a “view more” link which directs the remaining judges to the social feed to reengage the potential judge 303 with the application. At step, 314, the system 301 places the case in a “CLOSED” state. Returning back to step 306, after the pool of X number of potential judges of the new (based on their previously selected interests) have been notified, the system 301 sets the judge verdict timer to X hours. After X hours have transpired, the system 301 determines if judgement has been cast by the private users, at step 318. If judgement has not been cast, then the system 301 returns to step 306. If judgement has been cast, the system 301 places the case in a “CLOSED” state in step 314.

Returning to step 304, if the case visibility is determined to be social, then at step 320, the case appears in the social feed. At step 322, the potential judge 303 opens the case and reviews the evidence. At step 324, the potential judge 303 casts a vote. In one embodiment, the potential judge 303 may leave an opinion.

Returning to step 320, when the case appears in the social feed, then the system 301 sets the social case expiry time to X hours. Steps 324 and 326 converge at step 328, where the system determines if time X has expired. If time X has expired, then at step 330 the system 301 determines if the verdicts cast by all of the users in the social feed are equal (i.e., if the verdicts are a draw). If the verdicts cast are equal, then the case is placed in the “APPEALED” state at step 332. If the verdicts cast are not equal, then a verdict is rendered based on the highest number of votes in favor of the plaintiff or the defendant (step 334). At step 336, judgement is delivered to litigants and witnesses 305 via push notification, such as push notification 152 of FIG. 1. At step, 314, the system 301 places the case in a “CLOSED” state.

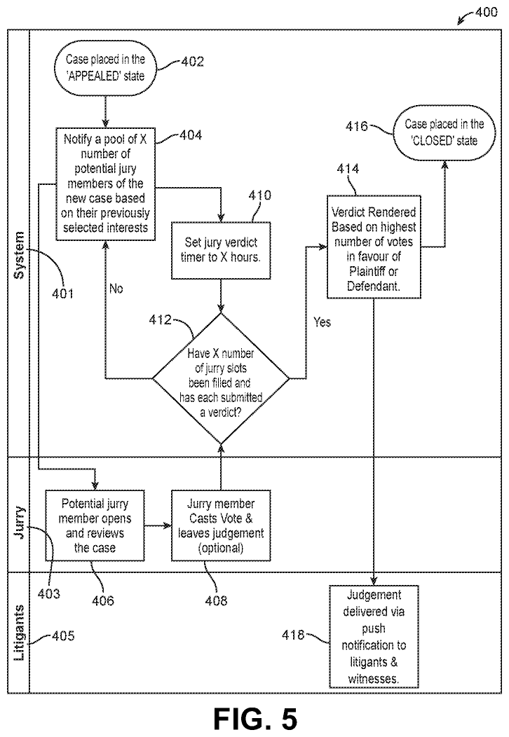

With respect to FIG. 5, a method 400 for an appeals process within the system platform 100 of FIG. 1 is illustrated. At step 402, the appeals process begins with a case that is placed in the “APPEALED” state. In one embodiment, this is the case from step 332 of FIG. 4. At step 404, a pool of X number of potential jury members 403 of the new case (based on their previously selected interests) are notified on the potential jury members' 403 computing device 102 via service 150 being push notifications if a token is active or alternatively by email. At step 406, the notified potential jury members 403 open and review the case with the application 122 on the potential jury members' 403 computing device 102. At step 408, each jury member 403 casts a vote. In one embodiment, the potential jury members 403 may leave an opinion.

Returning to step 404, the system 401 also sets a jury verdict timer to X hours at step 410. At step 412, the system 401 determines (1) if a certain number of jury slots have been filled, and (2) has each jury member submitted a verdict (see step 408). In one embodiment, if a vote is cast but no judgement is rendered (optional) then the case is closed. In another embodiment, if no vote has been cast then the case may not proceed, and only the judgement is optional. If neither (1) or (2) have been satisfied, then the system 401 returns to step 404. If both (1) and (2) have been satisfied, then a verdict is rendered based on the highest number of votes in favor of the plaintiff or the defendant as cast by the jury 403. At step 416, the case is placed in a “CLOSED” state by the system 401. At step 418, judgement is delivered to litigants and witnesses 405 via push notification, such as push notification 152 of FIG. 1.

System embodiments include computing devices such as a server computing device, a buyer computing device, and a seller computing device, each comprising a processor and addressable memory and in electronic communication with each other. The embodiments provide a server computing device that may be configured to: register one or more buyer computing devices and associate each buyer computing device with a buyer profile; register one or more seller computing devices and associate each seller computing device with a seller profile; determine search results of one or more registered buyer computing devices matching one or more buyer criteria via a seller search component. The service computing device may then transmit a message from the registered seller computing device to a registered buyer computing device from the determined search results and provide access to the registered buyer computing device of a property from the one or more properties of the registered seller via a remote access component based on the transmitted message and the associated buyer computing device; and track movement of the registered buyer computing device in the accessed property via a viewer tracking component. Accordingly, the system may facilitate the tracking of buyers by the system and sellers once they are on the property and aid in the seller's search for finding buyers for their property. The figures described below provide more details about the implementation of the devices and how they may interact with each other using the disclosed technology.

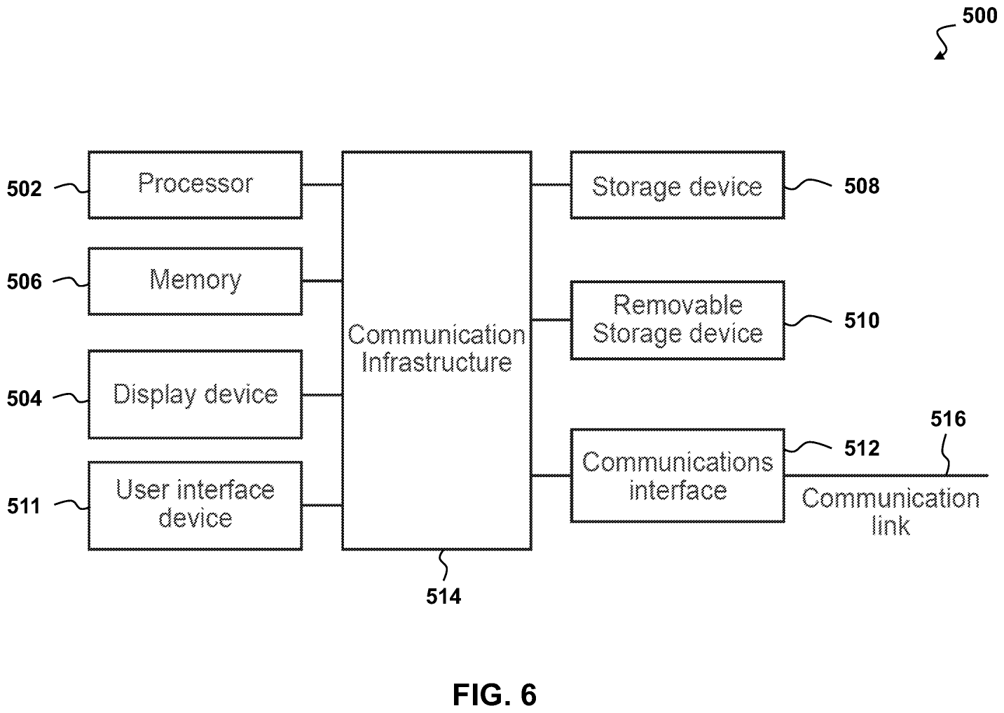

FIG. 6 is a high-level block diagram 500 showing a computing system comprising a computer system useful for implementing an embodiment of the system and process, disclosed herein. Embodiments of the system may be implemented in different computing environments. The computer system includes one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 514 may be in the form of signals such as electronic, electromagnetic, optical, or other signals capable of being received by communications interface 514, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

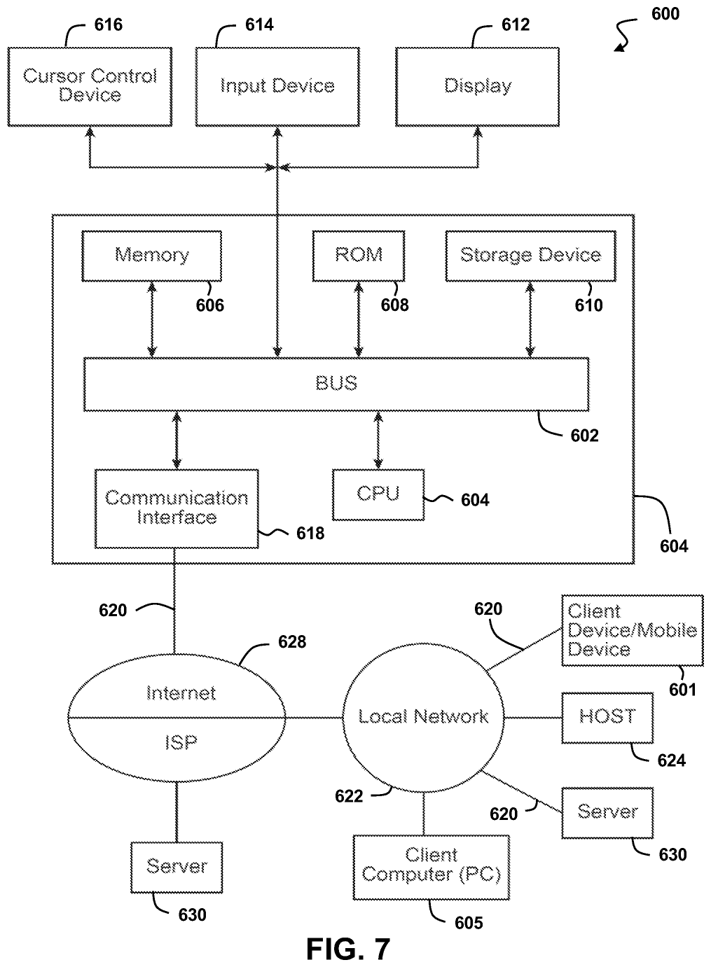

FIG. 7 shows a block diagram of an example system 600 in which an embodiment may be implemented. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 604 for execution. Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 604 for execution. For example, the instructions may initially be carried on a magnetic disk of a remote computer. The remote computer can load the instructions into its dynamic memory and send the instructions over a telephone line using a modem. A modem local to the server 630 can receive the data on the telephone line and use an infrared transmitter to convert the data to an infrared signal. An infrared detector coupled to the bus 602 can receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic or optical signals that carry digital data streams. The signals through the various networks and the signals on the network link 620 and through the communication interface 618, which carry the digital data to and from the server 630, are exemplary forms or carrier waves transporting the information.

In another embodiment of the server 630, interface 618 is connected to a network 622 via a communication link 620. For example, the communication interface 618 may be an integrated services digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms or carrier waves transporting the information.

The server 630 can send/receive messages and data, including e-mail, program code, through the network, the network link 620 and the communication interface 618. Further, the communication interface 618 can comprise a USB/Tuner and the network link 620 may be an antenna or cable for connecting the server 630 to a cable provider, satellite provider or other terrestrial transmission system for receiving messages, data and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and can depend on performance of the system 600 implementing the embodiments. As such, the logical operations constituting said example versions of the embodiments are referred to for e.g., as operations, steps or modules.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630.

The system 600 can further include computers (e.g., personal computers, computing nodes) 605 operating in the same manner as client devices 601, where a user can utilize one or more computers 605 to manage data in the server 630.

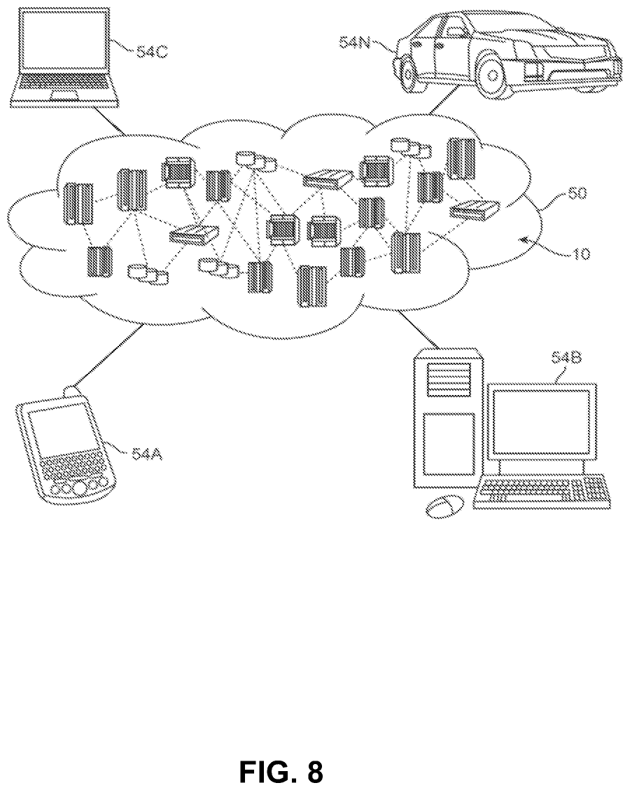

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

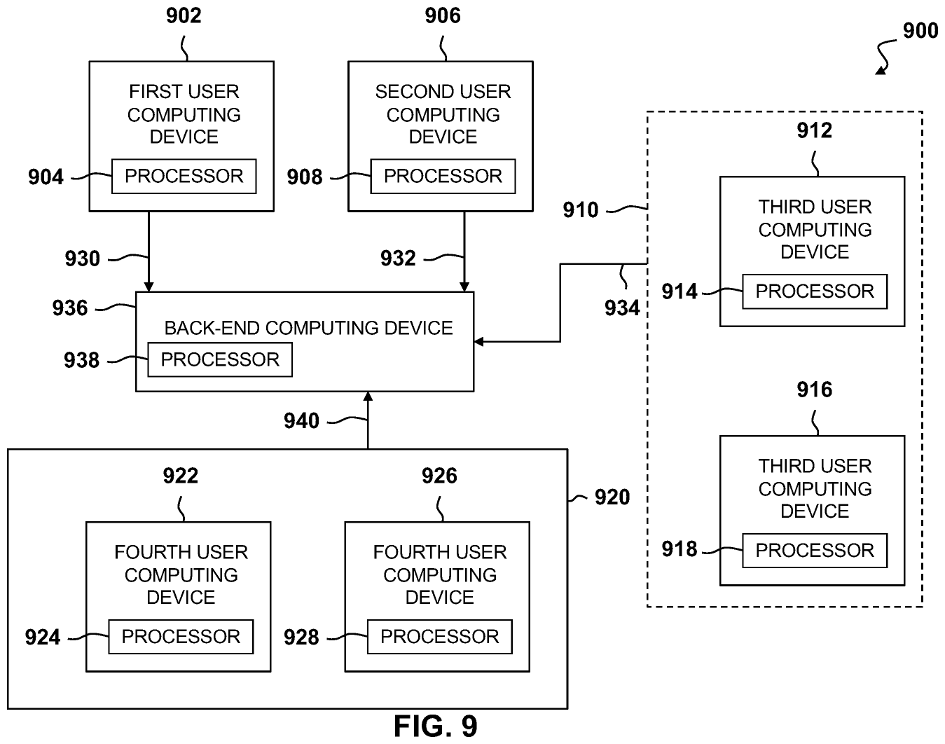

FIG. 9 depicts a high-level block diagram of a computing system 900 for an automated dispute resolution platform. The system 900 may include a first user computing device 902 having a processor 904; a second user computing device 906 having a processor 908; a set 910 of one or more third user computing devices 912,916 having respective processors 914, 918; at least one 920 fourth user computing device 922,926 each having a respective processor 924, 926; and a back-end computing device 936 having a processor 938. While computing devices and processors are shown for the sake of illustration, each computing device may also have addressable memory, a display, a user interface, and the like as shown in FIGS. 2, 6, 7, and 8.

The processor 904 of the first user computing device 902 may be configured to: complete a case creation form, where the case creation form comprises written evidence and at least one image; and transmit 930 the completed case creation form to the back-end computing device 936.

The processor 908 of the second user computing device 906 may be configured to: transmit 932 a defendant case served form to the back-end computing device 932. The case served form may be based on the completed case creation form.

The processors 914, 918 of the set 910 of the one or more third user computing devices 912, 916 may be configured to: transmit 934 a witness case served form to the back-end computing device 936. The case served form may be based on the completed case creation form.

The processors 924, 928 of the at least one 920 fourth user computing device 922, may be configured to: determine 940 a judgement based on: the completed case creation form and the defendant case served form.

The processor 938 of the web-enabled, back-end computing device 936 may be configured to: generate a case based on the completed case creation form; apply a served state to the generated case; generate a deadline for the second user computing device to accept the generated case in the served state; apply a removed state to the generated case if the second user computing device does not accept the generated case within the generated deadline; apply a summoned state to the generated case if the second user computing device accepts the generated case within the generated deadline; generate a deadline for the set of one or more third user computing devices to accept the generated case in the summoned state; remove at least one third user computing device from the set of one or more third user computing devices if the at least one third user computing device does not accept the generated case within the generated deadline; apply an opened state to the generated case after at least one of: the transmitted witness case served form may be received and the at least one third user computing device may be removed; determine a verdict based on the determined judgment of the at least one fourth user computing device; and/or apply a closed state to the generated case after the verdict may be determined.

The first user computing device 902 may be used by a plaintiff user. The second user computing device 906 may be used by a defendant user. The set 910 of third user computing devices 912, 916 may be used by witness users. The at least one 920 fourth user computing devices 922, 926 may be used by judge users. The back-end computing device 936 may be a remote server, such as a cloud server.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a first user computing device having a processor and addressable memory, wherein the processor of the first user computing device is configured to:
complete a case creation form, wherein the case creation form comprises written evidence and at least one image;
transmit the completed case creation form;
a second user computing device having a processor and addressable memory, wherein the processor of the second user computing device is configured to:
transmit a defendant case served form, wherein the case served form is based on the completed case creation form;
a set of one or more third user computing devices having a processor and addressable memory, wherein the processor of the set of one or more third user computing devices is configured to:
transmit a witness case served form, wherein the case served form is based on the completed case creation form;
at least one fourth user computing device having a processor and addressable memory, wherein the processor of the at least one fourth user computing device is configured to:
determine a judgement based on: the completed case creation form and the defendant case served form;
a web-enabled, back-end computing device, wherein the processor of the web-enabled, back-end computing device is configured to:
generate a case based on the completed case creation form;
apply a served state to the generated case;
generate a deadline for the second user computing device to accept the generated case in the served state;
apply a removed state to the generated case if the second user computing device does not accept the generated case within the generated deadline;
apply a summoned state to the generated case if the second user computing device accepts the generated case within the generated deadline;
generate a deadline for the set of one or more third user computing devices to accept the generated case in the summoned state;
remove at least one third user computing device from the set of one or more third user computing devices if the at least one third user computing device does not accept the generated case within the generated deadline;
apply an opened state to the generated case after at least one of: the transmitted witness case served form is received and the at least one third user computing device is removed;
determine a verdict based on the determined judgment of the at least one fourth user computing device; and
apply a closed state to the generated case after the verdict is determined.

2. The system of claim 1, wherein the processor of the web-enabled, back-end computing device is further configured to:
send a notification to the first user computing device when the generated case is in the summoned state.

3. The system of claim 1, wherein applying the served state to the generated case further comprises:
determine, by the processor of the web-enabled, back-end computing device, if the second user computing device has a user account.

4. The system of claim 3, wherein the processor of the web-enabled, back-end computing device is further configured to:
send an account creation link to the second user computing device if the second user computing device does not have the user account; and
create the user account based on the sent account creation link.

5. The system of claim 3, wherein the processor of the web-enabled, back-end computing device is further configured to:
send a push notification to the user account of the second user computing device.

6. The system of claim 1, wherein applying the opened state to the generated case further comprises:
determine, by the processor of the web-enabled, back-end computing device, if a third user computing device from the set of one or more third user computing devices has a user account.

7. The system of claim 6, wherein the processor of the web-enabled, back-end computing device is further configured to:
send an account creation link to the third user computing device if the third user computing device does not have the user account; and
create the user account based on the sent account creation link.

8. The system of claim 6, wherein the processor of the web-enabled, back-end computing device is further configured to:
send a push notification to the user account of the third user computing device.

9. The system of claim 1, wherein transmitting the witness case served form further comprises transmitting written evidence.

10. The system of claim 1, wherein transmitting the witness case served form further comprises transmitting at least one image.

11. The system of claim 1, wherein the processor of the web-enabled, back-end computing device is further configured to:
send the determined verdict to the first user computing device, the second user computing device, and the set of one or more third user computing devices.

12. The system of claim 1, wherein the processor of the at least one fourth user computing device is further configured to:
determine a judgement further based on the transmitted witness case served form.

13. The system of claim 1, wherein the processor of the web-enabled, back-end computing device is further configured to:
apply an appealed state to the generated case if the first user computing device requests an appeal.

14. The system of claim 1, wherein the processor of the web-enabled, back-end computing device is further configured to:
apply an appealed state to the generated case if the first user computing device requests an appeal.

15. The system of claim 14, wherein the processor of the web-enabled, back-end computing device is further configured to:
send the generated case in the appealed state to a pool of a set number of the at least one fourth computing devices;
receive votes from the pool of the set number of the at least one fourth computing devices;
determine a verdict on the generated case in the appealed state based on the received votes; and
apply a closed state to the generated case after the verdict is determined.

16. A method comprising:
completing, by a processor of a first user computing device, a case creation form, wherein the case creation form comprises written evidence and at least one image;
transmitting, by the processor of a first user computing device, the completed case creation form;
transmitting, by a processor of a second user computing device, a defendant case served form, wherein the case served form is based on the completed case creation form;
transmitting, by a processor of a set of one or more third user computing devices, a witness case served form, wherein the case served form is based on the completed case creation form; and
providing, by a processor of at least one fourth user computing device, a judgement based on: the completed case creation form, the defendant case served form, and the witness case served form.

17. The method of claim 16, further comprising:
generating, by a processor of a web-enabled, back-end computing device, a case based on the completed case creation form; and
applying, by the processor of a web-enabled, back-end computing device, a served state to the generated case.

18. The method of claim 17, further comprising:
generating, by the processor of a web-enabled, back-end computing device, a deadline for the second user computing device to accept the generated case in the served state;
applying a removed state to the generated case if the second user computing device does not accept the generated case within the generated deadline; and
applying a summoned state to the generated case if the second user computing device accepts the generated case within the generated deadline.

19. The method of claim 18, further comprising:
generating, by the processor of a web-enabled, back-end computing device, a deadline for a third user computing device from the set of one or more third user computing devices to accept the generated case in the summoned state;
removing, by the processor of a web-enabled, back-end computing device, the third user computing device if the third user computing device does not accept the generated case within the generated deadline; and
applying an opened state to the generated case after at least one of: the transmitted witness case served form is received and the third user computing device is removed.

20. The method of claim 19, further comprising:
determining, by the processor of a web-enabled, back-end computing device, a verdict based on the determined judgment of the at least one fourth user computing device; and
applying, by the processor of a web-enabled, back-end computing device, a closed state to the generated case after the verdict is determined.
